(19) United States
(12) Patent Application Publication
(10) Pub. No.: US 2010/0253660 A1
(43) Pub. Date: Oct. 7, 2010

(54) DISPLAY DEVICE AND ELECTRONIC APPARATUS EQUIPPED WITH THE SAME

(75) Inventor: Kazuyuki Hashimoto, Kobe (JP)

Correspondence Address: KIRTON AND MCCONKIE, 60 EAST SOUTH TEMPLE,, SUITE 1800, SALT LAKE CITY, UT, 84111, US

(73) Assignee: TPO DISPLAYS CORP., Miao-Li County (TW)

(21) Appl. No.: 12/725,675

(22) Filed: Mar. 17, 2010

(30) Foreign Application Priority Data
Apr. 2, 2009 (JP) 2009-090091

(51) Int. Cl. G09G 3/36; G09G 5/00

(52) U.S. Cl. 345/207; 345/102

(57) ABSTRACT

A display device includes a display layer, a first glass substrate, a second glass substrate, an external light sensor, a black matrix and a color filter layer. The display layer has polarizing or light-emitting display components, which are arranged in a matrix. The first glass substrate and the second glass substrate are respectively disposed over and under the display layer. The external light sensor is disposed on an interface between the first glass substrate and the display layer for detecting an external light passing through the second glass substrate incident to the external light sensor. The black matrix is disposed on an interface between the second glass substrate and the display layer. The external light passing through the second glass substrate is sheltered by the black matrix. The color filter layer is deposited on the black matrix and has a specified transmittance spectrum property.

### FIELD OF THE INVENTION

The present invention relates to a display device having a display panel for detecting the ambient light. The present invention also relates to an electronic apparatus equipped with such a display device.

### BACKGROUND OF THE INVENTION

Nowadays, the display device of an electronic apparatus (especially the mobile apparatus used in the outdoor environment, for example, a vehicular navigation apparatus, a mobile phone, or the like) usually has a luminance adjustable function for adjusting the luminance according to the brightness of the ambient light. For example, PCT Invention Patent Application WO 99/022962 disclosed a display system. In the display system, the ambient light is detected by an ambient light sensor, and the luminance of the display is adjusted by a brightness controller according to the brightness of the ambient light. By means of this function, the luminance of the display is increased when the electronic apparatus is used in a bright environment (e.g. in the outdoor environment) during the day, or the luminance of the display is decreased when the electronic apparatus is used in a dark environment (e.g. in the indoor environment) or during the night.

The conventional display device, however, still has some drawbacks. For example, due to light reflection within the displaying module of the display device, the ambient light fails to be accurately detected. Therefore, it is necessary to obviate the above drawbacks.

### SUMMARY OF THE INVENTION

An object of the present invention provides a display device and an electronic apparatus having such display device in order to accurately detect the ambient light.

For achieving the above objects, the present invention provides a display device. The display device includes a display layer, a first glass substrate, a second glass substrate, an external light sensor, a black matrix and a color filter layer. The display layer has polarizing or light-emitting display components, which are arranged in a matrix. The first glass substrate and the second glass substrate are respectively disposed over and under the display layer. The external light sensor is disposed on an interface between the first glass substrate and the display layer for detecting an external light passing through the second glass substrate incident to the external light sensor. The black matrix is disposed on an interface between the second glass substrate and the display layer. The external light passing through the second glass substrate is sheltered by the black matrix. The color filter layer is deposited on the black matrix and has a specified transmittance spectrum property.

The use of the color filter layer can reduce the influence of the light reflected by the black matrix, so that the accuracy of detecting the ambient light is enhanced.

Preferably, the color filter layer is produced by the same process of fabricating color filter layers between grids of the black matrix.

Since the no special fabricating process is required to form the color filter layer on the black matrix, the fabricating cost is reduced.

In an embodiment, the color filter layer is formed by depositing one or more color filter layers having low transmittance to the external light passing through the second glass substrate, and/or to a diode light emitted from organic light emitting diodes if the display components are organic light emitting diodes, or to a backlight emitted from a backlight source if the display components are liquid crystals and the display device has the backlight source.

In an embodiment, the display device further includes a compensating sensor, which is disposed on the interface between the first glass substrate and the display layer and arranged in a region where the external light passing through the second glass substrate is hindered by the black matrix. The compensating sensor is used for detecting an external factor which is irrelevant to the external light passing through the second glass substrate, thereby compensating the influence of the external factor. The external factor includes temperature, and if the display components are liquid crystals and the display device has a backlight source, the external factor further includes a backlight emitted from the backlight source.

As such, the use of the compensating sensor can increase the accuracy of detecting the ambient light.

In an embodiment, the display device can be installed on an electronic apparatus such as a mobile phone, a watch, a personal digital assistant (PDA), a laptop computer, a navigation apparatus, a handheld game console, an outdoor-type large screen (e.g. Aurora Vision), or the like.

The present invention provides a display device and an electronic apparatus equipped with the display device in order to accurately detect the ambient light.

### BRIEF DESCRIPTION OF THE DRAWINGS

The above objects and advantages of the present invention will become more readily apparent to those ordinarily skilled in the art after reviewing the following detailed description and the accompanying drawings, in which:

FIG. 1 is a schematic diagram illustrating an electronic apparatus with a display device according to an embodiment of the present invention;

FIGS. 2A and 2B are cross-sectional views illustrating two types of display panels of conventional display devices;

FIGS. 3A and 3B are cross-sectional views illustrating two types of display panels of the display devices according to a first embodiment of the present invention;

FIGS. 4A and 4B are plots illustrating the efficacy of arranging the color filter layers on the surface of the black matrix for reducing the backlight reflected by the black matrix in the LCD display device according to the first embodiment of the present invention;

FIG. 5 is a plot illustrating a transmittance spectrum for the R(red), G(green) and B(blue) color filter layers;

FIG. 6 is a plot illustrating the efficacy of arranging the color filter layers on the surface of the black matrix for reducing the diode light reflected by the black matrix in the OLED display device according to the first embodiment of the present invention;

FIG. 7 is a plot illustrating the efficacy of arranging the color filter layers on the surface of the black matrix for reducing the external light reflected by the black matrix in the display device according to the first embodiment of the present invention;

FIGS. 8A and 8B are cross-sectional views illustrating two types of display panels of the display devices according to a second embodiment of the present invention;

FIG. 9 is a schematic functional block diagram illustrating an exemplary display device according to the second embodiment of the present invention;

FIG. 10 is a schematic functional block diagram illustrating another exemplary display device according to the second embodiment of the present invention; and

FIG. 11 is a schematic diagram illustrating the configurations of the sensor output computing part of the display device according to the second embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

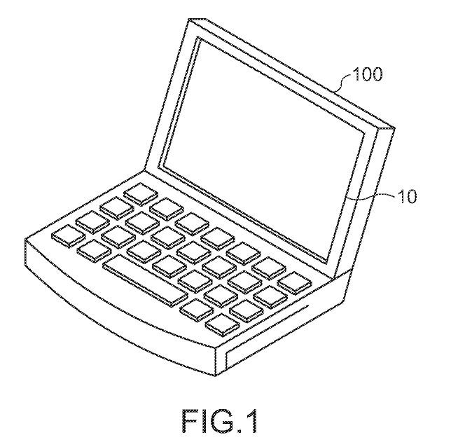

FIG. 1 is a schematic diagram illustrating an electronic apparatus with a display device according to an embodiment of the present invention. In FIG. 1, the electronic apparatus 100 is illustrated by referring to a laptop computer. Nevertheless, the electronic apparatus 100 may be a mobile phone, a personal digital assistant (PDA), a navigation apparatus, a handheld game console, or the like.

The electronic apparatus 100 comprises a display device 10. The display device 10 has a display panel for displaying images. The display device 10 has a function of detecting the ambient light. In addition, the display device 10 is capable of varying the display luminance according to the detected brightness of the ambient light. In addition, the display device 10 can compute and display the intensity of a specified wavelength light (e.g. UV light) according to the detected ambient light, thereby prompting the user.

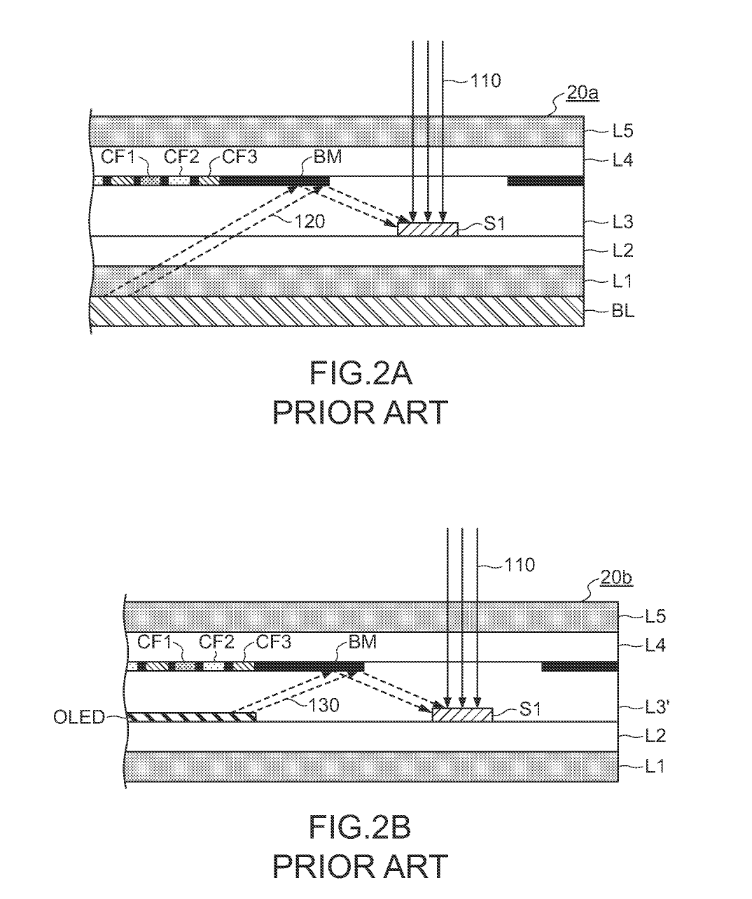

FIG. 2A is a schematic cross-sectional view illustrating a display panel of a liquid crystal display (LCD) device. From bottom to top of the laminate, the display panel 20a comprises a backlight source BL, a first polarizer L1, a first glass substrate L2, a display layer L3, a second glass substrate L4 and a second polarizer L5. In addition, a black matrix BM is formed on the interface between the second glass substrate L4 and the display layer L3. The black matrix BM has a light-sheltering property. The black matrix BM is a grid-shaped structure formed in the active area of the display panel 20a for practically displaying images. Several color filter layers CF1, CF2 and CF3 of specified colors (e.g. R(red), G(green) and B(blue)) are formed between the grids. In addition, liquid crystal display components (not shown) are formed in the display layer L3 in a matrix arrangement. When a specified voltage is applied, the backlight emitted from the backlight source is polarized by the liquid crystal display components. The matrix-arranged liquid crystal display components are respectively aligned with the color filter layers CF1, CF2 and CF3 that are arranged between the grids of the black matrix BM. As such, when the voltage is applied to a specified liquid crystal display component, the display panel 20a will exhibit the color of the color filter layer corresponding to the specified liquid crystal display component (e.g. one of the colors R, G and B).

In a case that the display device 10 has a function of detecting the ambient light, an external light sensor S1 is disposed on the interface between the first glass substrate L2 and the display layer L3 of the display panel 20a. The external light 110 passing through the second polarizer L5 and the second glass substrate L4 is detectable by the external light sensor S1. That is, when the light is directed to the external light sensor S1, the photocurrent that is excited by the light will flow in the external light sensor S1.

Ideally, only the external light 110 passing through the second polarizer L5 and the second glass substrate L4 (as indicated by a solid arrow) is detectable by the external light sensor S1. In practice, since the backlight 120 emitted from the backlight source BL is reflected by the black matrix BM (as indicated by a dotted line), the backlight 120 is also received by the external light sensor S1.

FIG. 2B is a schematic cross-sectional view illustrating a display panel of an organic light emitting diode (OLED) display device. In comparison with the display panel 20a of FIG. 2A, the display panel 20b of FIG. 2B has no backlight source BL because the display layer L3′ has a self-luminescent OLED matrix in place of the liquid crystal display components. When a specified voltage is applied, the OLED matrix can self-illuminate. As the display panel 20a in FIG. 2A, the matrix-arranged OLED of a white OLED display device are respectively aligned with the color filter layers CF1, CF2 and CF3 that are arranged between the grids of the black matrix BM. As such, when the voltage is applied to a specified OLED, the display panel 20b will exhibit the color of the color filter layer corresponding to the specified OLED (e.g. one of the colors R, G and B).

As the display panel 20a in FIG. 2A, the light 130 emitted from the OLED of the display panel 20b is reflected by the black matrix BM (as indicated by a dotted line), and the light 130 is also received by the external light sensor S1. As such, the accuracy of detecting the ambient light is reduced.

Moreover, regardless of whether the LCD display device or the OLED display device is used, the external light that does not directly irradiate the external light sensor S1 will affect the accuracy of the external light sensor S1. In other words, when the external light is reflected by the black matrix BM, the stray light generated within the display layer L3 (or L3′) will affect the accuracy of the external light sensor S1.

In addition to the light-sheltering property, the black matrix BM also has high reflectivity. As such, the light reflected by the black matrix BM will adversely affect the accuracy of detecting the ambient light.

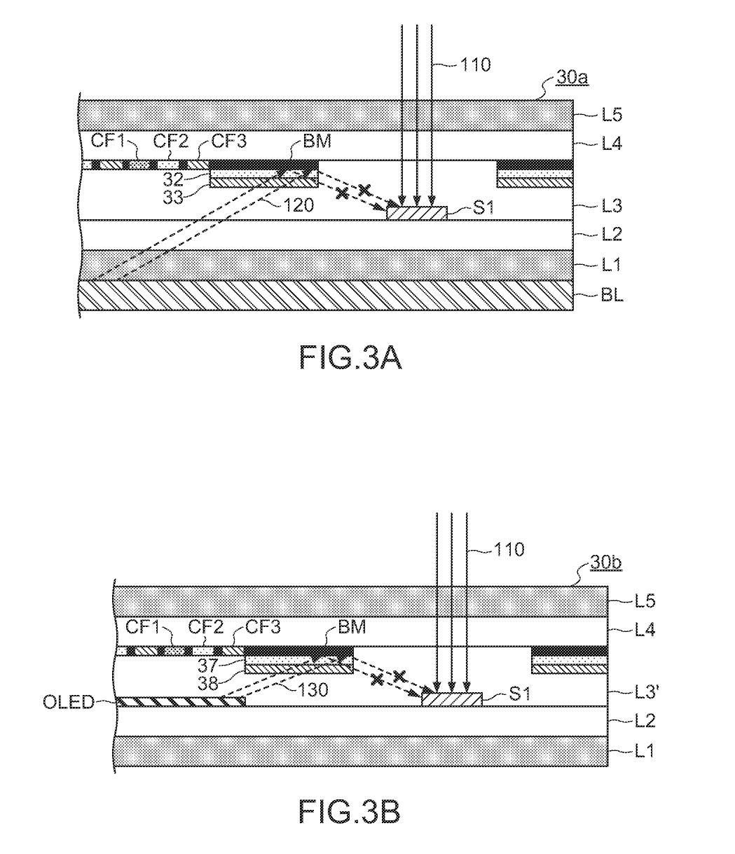

FIGS. 3A and 3B are cross-sectional views illustrating two types of display panels of the display devices according to a first embodiment of the present invention.

FIG. 3A is a schematic cross-sectional view illustrating a display panel of a liquid crystal display (LCD) device. In comparison with the display panel 20a of FIG. 2A, layered color filter layers 32 and 33 are deposited on the surface of the black matrix BM of the display panel 30a of FIG. 3A. In views of cost-effectiveness, the color filter layers 32 and 33 are produced by the same process of fabricating the color filter layers CF1, CF2 and CF3, which are arranged between the grids of the black matrix BM. The color filter layers 32 and 33 have different colors. The colors of the color filter layers 32 and 33 are selected according to the spectrum of the light which is supposed not to be detected by but becomes accessible to the external light sensor S1 as reflected by the black matrix BM.

For preventing the backlight, which is emitted from the backlight source BL and reflected by the black matrix BM, from adversely affecting the external light sensor S1, a red color filter layer and a blue color filter layer are respectively used as the color filter layers 32 and 33 of the display panel 30a of FIG. 3A.

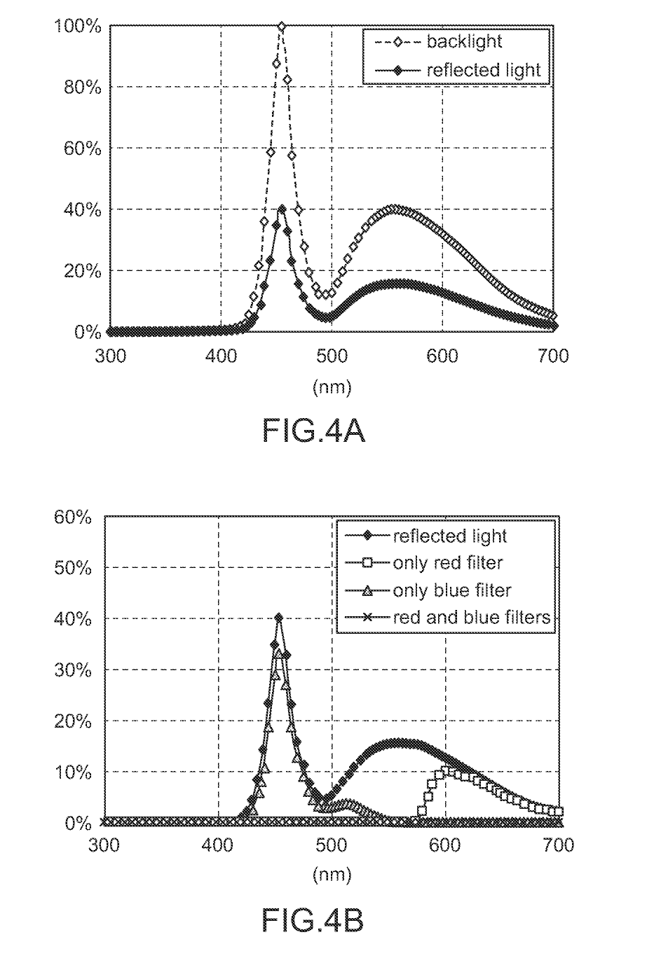

FIGS. 4A and 4B are plots illustrating the efficacy of using the red color filter layer and the blue color filter layer as the color filter layers 32 and 33 for reducing the backlight 120 reflected by the black matrix BM.

FIG. 4A is a plot illustrating the spectrum of the backlight 120 emitted from the backlight source BL and passing through the first polarizer L1 (as indicated by a dotted line), and the spectrum of the backlight 120 emitted from the backlight source BL and reflected by the black matrix BM in the case that the color filter layers 32 and 33 are omitted (as indicated by a solid line). Whereas, FIG. 4B is a plot illustrating the spectrum of the backlight 120 reflected by the black matrix BM in a case that one or both of the red color filter layer and the blue color filter layer are used as the color filter layers 32 and 33. In FIGS. 4A and 4B, the horizontal axle indicates the wavelength (nm), and the vertical axle indicates relative intensity (%) of a corresponding wavelength.

As can be seen from FIG. 4A, if the color filter layers 32 and 33 are absent, about 40% of the backlight 120 is reflected by the black matrix BM. In a case that the color filter layers are formed on the surface of the black matrix BM, with respect to the backlight 120, about 9.2% is reflected when only the red color filter layer is used, and about 13.5% is reflected when only the blue color filter layer is used (see FIG. 4B). The backlight 120 reflected by the black matrix BM is reduced to about 0.1% when both of the red color filter layer and the blue color filter layer are used. As such, when the red color filter layer and the blue color filter layer are used as the color filter layers 32 and 33, the backlight 120 is almost not reflected by the black matrix BM. In this situation, the backlight 120 reflected by the black matrix BM will no longer adversely affect the accuracy of detecting the ambient light by the external light sensor S1.

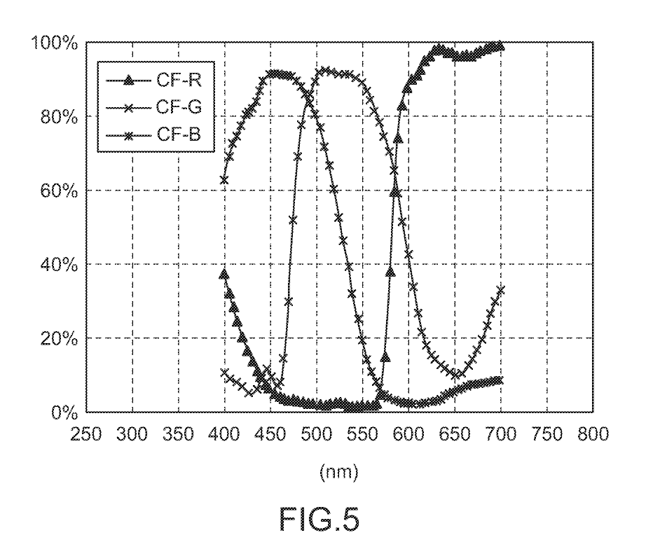

FIG. 5 is a plot illustrating a transmittance spectrum of the R(red), G(green) and B(blue) color filter layers. In FIG. 5, the horizontal axle indicates the wavelength (nm), and the vertical axle indicates corresponding transmittance (%). Referring to FIG. 5, the red color filter layer is transparent to the light having a wavelength longer than about 600 nm, the green color filter layer is transparent to the light having a wavelength in the range between 480 nm and 570 nm, and the blue color filter layer is transparent to the light having a wavelength in the range between 425 nm and 500 nm. Due to the properties of these color filter layers, a color filter layer with low transmittance to a specific light is selected in order to prevent the specified light from reaching the black matrix BM.

FIG. 3B is a schematic cross-sectional view illustrating a display panel of an organic light emitting diode (OLED) display device. In comparison with the display panel 20b of FIG. 2B, color filter layers 37 and 38 are deposited on the surface of the black matrix BM of the display panel 30b of FIG. 3B. In views of cost-effectiveness, the color filter layers 37 and 38 are produced by the same process of fabricating the color filter layers CF1, CF2 and CF3, which are arranged between the grids of the black matrix BM. The color filter layers 37 and 38 have different colors. The colors of the color filter layers 37 and 38 are selected according to the spectrum of the light which is supposed not to be detected by but becomes accessible to the external light sensor S1 as reflected by the black matrix BM.

For preventing the diode light 130, which is emitted from the OLED and reflected by the black matrix BM, from adversely affecting the external light sensor S1, a red color filter layer and a blue color filter layer are respectively used as the color filter layers 37 and 38 of the display panel 30b of FIG. 3B.

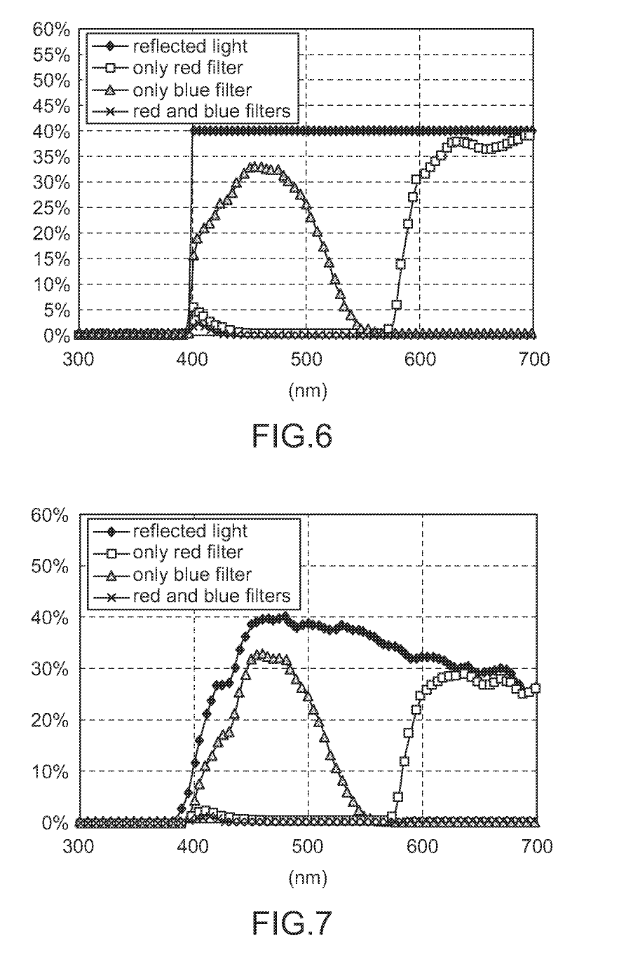

FIG. 6 is a plot illustrating the efficacy of using the red color filter layer and the blue color filter layer as the color filter layers 37 and 38 for reducing the diode light 130 reflected by the black matrix BM.

FIG. 6 illustrates the spectrum of the diode light 130 reflected by the black matrix BM in the case that the color filter layers 37 and 38 are omitted or one or both of the red color filter layer and the blue color filter layer are used as the color filter layers 37 and 38. In FIG. 6, the horizontal axle indicates the wavelength (nm), and the vertical axle indicates relative intensity (%) of a corresponding wavelength.

For example, in a case that the color filter layers 37 and 38 are absent, about 40% of the diode light 130 emitted from the OLED is reflected by the black matrix BM. In a case that the color filter layers are formed on the surface of the black matrix BM, with respect to the diode light 130, about 14.0% is reflected when only the red color filter layer is used, and about 11.5% is reflected when only the blue color filter layer is used (see FIG. 6). The diode light 130 reflected by the black matrix BM is reduced to about 0.2% when both of the red color filter layer and the blue color filter layer are used. As such, when the red color filter layer and the blue color filter layer are used as the color filter layers 37 and 38, the diode light 130 emitted from the OLED is almost not reflected by the black matrix BM. In this situation, the diode light 130 reflected by the black matrix BM will no longer adversely affect the accuracy of detecting the ambient light by the external light sensor S1.

Moreover, regardless of whether the conventional LCD display device or the conventional OLED display device is used, the external light that does not directly irradiate the external light sensor S1 will affect the accuracy of the external light sensor S1. In other words, when the external light is reflected by the black matrix BM, the stray light generated within the display layer L3 (or L3′) will affect the accuracy of the external light sensor S1. On the other hand, since the color filter layers are formed on the black matrix of the display panel of the present invention (see FIGS. 3A and 3B), the influence of the stray light will be reduced or eliminated.

FIG. 7 is a plot illustrating the efficacy of arranging the color filter layers on the surface of the black matrix for reducing the external light reflected by the black matrix in the display device according to the first embodiment of the present invention.

FIG. 7 illustrates the spectrum of the external light (e.g. the external light that is reflected by the first glass substrate L2) reflected by the black matrix BM in the case that the color filter layers 32 and 33 (or 37 and 38) are omitted or one or both of the red color filter layer and the blue color filter layer are used as the color filter layers 32 and 33 (or 37 and 38). In FIG. 7, the horizontal axle indicates the wavelength (nm), and the vertical axle indicates relative intensity (%) of a corresponding wavelength.

For example, in a case that the color filter layers 32 and 33 (or 37 and 38) are absent, about 40% of the external light is reflected by the black matrix BM. In a case that the color filter layers are formed on the surface of the black matrix BM, with respect to the external light before reflected, about 10.5% is reflected when only the red color filter layer is used, and about 10.0% is reflected when only the blue color filter layer is used (see FIG. 7). The external light reflected by the black matrix BM is reduced to about 0.1% when both of the red color filter layer and the blue color filter layer are used. As such, when the red color filter layer and the blue color filter layer are used as the color filter layers 32 and 33 (or 37 and 38), the external light is almost not reflected by the black matrix BM. In this situation, the external light reflected by the black matrix BM will no longer adversely affect the accuracy of detecting the ambient light by the external light sensor S1.

From the above description, due to the arrangement of the color filters layers of specified colors (i.e. with specified transmittance properties) on the surface of the black matrix, the influence of the light reflected by black matrix BM will be reduced or eliminated. As such, the accuracy of detecting the ambient light is enhanced.

As previously described, the accuracy of detecting the ambient light is influence by the light that is reflected by black matrix BM. Moreover, the accuracy of detecting the ambient light is also influenced by other factors (e.g. temperature).

As known, an ideal optical sensor generates photocurrent only during the optical sensor is irradiated by a light. In practice, even if the optical sensor is not irradiated by a light, dark current resulted from the external factor (e.g. temperature) possibly flows through the optical sensor. Moreover, in a LCD display device using a backlight source, since the backlight emitted from the backlight source directly irradiates the optical sensor, the photocurrent flowing through the optical sensor is not only induced by the external light but also the backlight.

For compensating the influence of the external factor (e.g. temperature) and/or the backlight, the display device further comprises a compensating sensor. The display device having such a compensating sensor will be illustrated as follows.

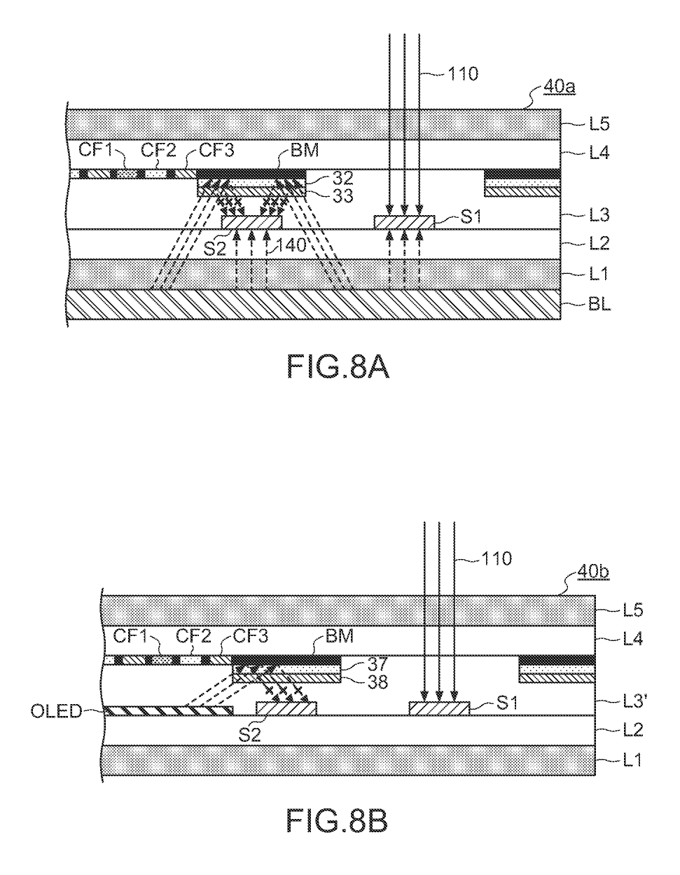

FIGS. 8A and 8B are cross-sectional views illustrating two types of display panels of the display devices according to a second embodiment of the present invention.

FIG. 8A is a schematic cross-sectional view illustrating a display panel of a liquid crystal display (LCD) device. The configurations of the display panel 40a of FIG. 8A are substantially identical to those of the display panel 30a of FIG. 3A, except that a compensating sensor S2 is disposed on the interface between the first glass substrate L2 and the display layer L3 and arranged in a region where the external light 110 passing through the second glass substrate L4 is hindered by the black matrix BM. FIG. 8B is a schematic cross-sectional view illustrating a display panel of an organic light emitting display (OLED) device. The configurations of the display panel 40b of FIG. 8B are substantially identical to those of the display panel 30b of FIG. 3B, except that a compensating sensor S2 is disposed on the interface between the first glass substrate L2 and the display layer L3′ and arranged in a region where the external light 110 passing through the second glass substrate L4 is hindered by the black matrix BM.

It is preferred that the compensating sensor S2 and the external light sensor S1 have identical properties and structures. For example, the compensating sensor S2 can detect the dark current (not shown), which is resulted from the external factor (e.g. temperature), and/or the backlight 140, which is emitted from the backlight source BL and passes through the first polarizer L1 and the first glass substrate L2.

Ideally, since the compensating sensor S2 and the external light sensor S1 have identical properties and structures, the magnitudes of the dark current flowing therein are considered to be identical in some circumstances. For example, in a case that the display panel has no backlight source BL or the backlight source BL is turned off, the photocurrent will not be induced by the irradiation within the compensating sensor S2 because the external light 110 is sheltered by the black matrix BM. In this situation, the current flowing through the compensating sensor S2 can be considered as the dark current resulted from the external light sensor S1.

In a case that the influence of the external factor (e.g. temperature) is negligible and the display device has the backlight source BL, the magnitudes of the photocurrent induced by the backlight from the backlight source BL are considered to be identical because the compensating sensor S2 and the external light sensor S1 have identical properties and structures. In this situation, the current flowing through the compensating sensor S2 can be considered as the photocurrent induced by the backlight from the backlight source BL in the external light sensor S1.

Since the compensating sensor S2 is arranged directly under the black matrix BM, the backlight or the diode light and the external light reflected by the black matrix BM have large influence on the compensating sensor S2. Referring to FIGS. 3˜7, the color filter layers 32 and 33 (or 37 and 38) with specified transmittance spectrum properties are deposited on the surface of the black matrix BM in order to prevent the backlight or the diode light and the external light from being reflected by the black matrix BM.

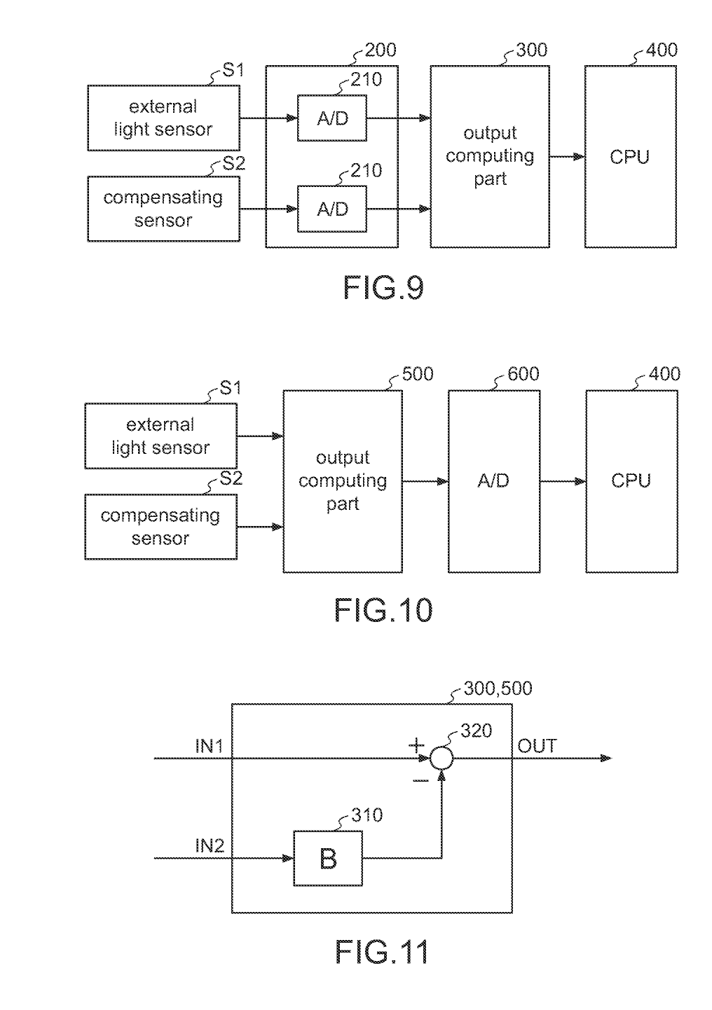

The functional block diagram of the display device using the compensating sensor S2 to detect the ambient light according to the second embodiment of the present invention will be illustrated as follows. FIG. 9 is a schematic functional block diagram illustrating an exemplary display device according to the second embodiment of the present invention.

As shown in FIG. 9, the display device comprises an external light sensor S1, a compensating sensor S2, a signal converting part 200, a sensor output computing part 300 and a controller 400 (e.g. CPU). By the signal converting part 200, the current-form signals outputted from the external light sensor S1 and the compensating sensor S2 are converted into digital or pulse signals that can be processed by the sensor output computing part 300. In this embodiment, the signal converting part 200 comprises a first analog-to-digital (A/D) converter 210 and a second analog-to-digital (A/D) converter 220, which are respectively connected to the external light sensor S1 and the compensating sensor S2. The signals outputted from the external light sensor S1 and the compensating sensor S2 are converted into digital signals by the first analog-to-digital (A/D) converter 210 and the second analog-to-digital (A/D) converter 220, respectively. According to the digital signals, the sensor output computing part 300 generates an output signal with the actual external light intensity, in which the influence of the temperature and/or the backlight or the diode light has been compensated. The controller 400 is used for controlling the operations of all components of the display device. For example, in a case that the display device is a LCD display device, the controller 400 can adjust the backlight luminance according to the signal outputted from the sensor output computing part 300.

Moreover, the display device may have the functional block diagram as shown in FIG. 10. FIG. 10 is a schematic functional block diagram illustrating another exemplary display device according to the second embodiment of the present invention.

As shown in FIG. 10, the display device comprises an external light sensor S1, a compensating sensor S2, a sensor output computing part 500, a signal converting part 600 and a controller 400 (e.g. CPU). In the display device of FIG. 10, the current outputted from the external light sensor S1 and the compensating sensor S2 can be directly processed by the sensor output computing part 500 in order to compensate the influence of the temperature and/or the backlight or the diode light. In other words, the operations of the display device are distinguished from the display device of FIG. 9 in these aspects. The signal converting part 600 is arranged between the sensor output computing part 500 and the controller 400. By the signal converting part 600, the analog-form signal outputted from the sensor output computing part 500 and corresponding to the intensity of the external light will be converted into a digital or pulse signal, which is then delivered to the controller 400.

The configurations of the sensor output computing part of the display device (see FIG. 9 or 10) will be illustrated with reference to FIG. 11.

As shown in FIG. 11, the sensor output computing part 300 (or 500) comprises a multiplier 310 and a subtracter 320. The analog or digital signal outputted from the compensating sensor S2 is inputted into the multiplier 310 through a second input end IN2, so that the analog or digital signal outputted from the compensating sensor S2 is multiplied by a correction coefficient B. The analog or digital signal outputted from the external light sensor S1 is inputted into the subtracter 320 through a first input end IN1, so that the signal outputted from the compensating sensor S2 and corrected by the multiplier 310 will be subtracted from the signal outputted from the external light sensor S1. As a consequence, output end OUT of the sensor output computing part 300 (or 500) will output an output signal with the actual external light intensity, in which the influence of the temperature and/or the backlight or the diode light has been compensated.

From the above description, since the use of the compensating sensor S2 can compensate the influence of the external factors irrelevant to the external light (e.g. the temperature and/or the backlight or the diode light), the accuracy of detecting the ambient light is enhanced.

It is noted that, however, those skilled in the art will readily observe that numerous modifications and alterations may be made while retaining the teachings of the invention.

For example, in the above embodiments, the color filter layer is illustrated by referring a red color filter layer or a blue color filter layer. Nevertheless, a specified color filter layer or a combination of plural color filter layers may be utilized as long as the wavelength of the light reflected by the black matrix has a low transmittance spectrum property.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display device, comprising:
a display layer having polarizing or light-emitting display components arranged in a matrix;
a first glass substrate and a second glass substrate respectively disposed over and under the display layer;
an external light sensor disposed on an interface between the first glass substrate and the display layer for detecting an external light passing through the second glass substrate incident to the external light sensor;
a black matrix disposed on an interface between the second glass substrate and the display layer, wherein the external light passing through the second glass substrate is sheltered by the black matrix; and
a color filter layer deposited on the black matrix.

2. The display device according to claim 1 wherein the color filter layer is produced by the same process of fabricating color filter layers between grids of the black matrix.

3. The display device according to claim 1 wherein the color filter layer is formed by depositing one or more color filter layers having low transmittance to the external light passing through the second glass substrate, and/or to a diode light emitted from organic light emitting diodes if the display components are organic light emitting diodes, or to a backlight emitted from a backlight source if the display components are liquid crystals and the display device has the backlight source.

4. The display device according to claim 3 wherein the color filter layer is formed by depositing a red color filter layer and a blue color filter layer.

5. The display device according to claim 1 further comprising a compensating sensor, which is disposed on the interface between the first glass substrate and the display layer and corresponded to the black matrix, for compensating influence of external factor thereon.

6. The display device according to claim 5 wherein the external factor includes temperature and a backlight emitted from a backlight source.

7. An electronic apparatus equipped with a display device according to claim 1.
